(19) United States
(12) Patent Application Publication
(10) Pub. No.: US 2009/0196617 A1
(43) Pub. Date: Aug. 6, 2009

(54) SINGLE CORE BIDIRECTIONAL OPTICAL DEVICE

(75) Inventors: Kentarou Yoshizaki, Kawasaki (JP); Takashi Yamane, Kawasaki (JP); Masaki Kuribayashi, Kawasaki (JP); Akitoshi Mesaki, Kawasaki (JP); Tetsuya Yamada, Kawasaki (JP); Yoshimitsu Sakai, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/340,645

(22) Filed: Dec. 20, 2008

(30) Foreign Application Priority Data
Dec. 20, 2007 (JP) 2007-329007

(51) Int. Cl. H04J 14/02

(52) U.S. Cl. 398/82

(57) ABSTRACT

A single core bidirectional optical device having a light emitting element that is provided on the terminal of one optical fiber and makes light incident to the optical fiber, and a light receiving element for receiving light of the optical fiber, comprises a wavelength multiplexing/demultiplexing coupler that is provided on an optical axis of light incident to and emitted from the optical fiber and includes therein wavelength separating film for separating the light to light of one side and light of another side for every wavelength; a light emitting element provided on the direction of the light of the one side which is separated by the wavelength multiplexing/demultiplexing coupler; and a light receiving element provided on the direction of the light of the other side which is separated by the wavelength multiplexing/demultiplexing coupler.

### CROSS-REFERENCE TO RELATED APPLICATION

This application is based upon and claims the benefit of priority of the prior Japanese Patent Application No. 2007-329007, filed on Dec. 20, 2007, the entire contents of which are incorporated herein by reference.

### BACKGROUND

The present invention relates to a single core bidirectional optical device that is connected to the terminal of one optical fiber and performs transmission/reception to/from the optical fiber, and particularly relates to a single core bidirectional optical device for which miniaturization and reception characteristics are improved.

### DESCRIPTION OF THE RELATED ART

A single core bidirectional optical device connected to the terminal of one optical fiber is applied to an optical transceiver or an optical module. The optical transceiver or the optical module as described above is being promoted to shift to a style defined in SFP (Small Form factor Pluggable). High-density packaging also has become mainstream in one core bidirectional optical devices for the purpose of miniaturization.

FIG. 10 is a side cross-sectional view showing the structure of a conventional one-core bidirectional optical device. The one-core bidirectional optical device 2000 of FIG. 10 is constructed by assembling a transmitter 2001, a receiver 2002, an optical fiber 2003, and a prism 2004 with wavelength-separating film in one housing 2005. The prism 2004 with the wavelength separating film is fixed to the end face of the optical fiber 2003. The wavelength separating film 2004a in the prism 2004 transmits light having a given wavelength λ1 therethrough and reflects light having another wavelength λ2.

The transmitter 2001 focuses transmission light having a wavelength λ1 emitted from a laser diode (LD), which is a light emitting element 2010, and couples the transmission light to the optical fiber 2003, and then transmits the light through an optical connector (not shown) to the outside. On the other hand, reception light having a wavelength λ2 transmitted from the outside is transmitted through the optical fiber 2003, and then is reflected by wavelength separating film 2004a in the prism 2004 provided at the tip of a ferrule 2003a, and condensed to the light receiving face of a photodiode (PD) as a light receiving element 2022 by the lens 2021 in the receiver 2002. According to the single core bidirectional optical device 2000 as described above, transmission light and reception light of different wavelengths λ1 and λ2 can be transmitted and received by one optical fiber 2003 (for example, JP-A-2000-180671).

However, it is difficult to miniaturize the conventional structure, and also there is a problem that optical crosstalk deterioration occurs. First, the receiver 2002 of the above construction has a lens 2021, and thus a focal distance for coupling light from the optical fiber is required on the optical system. By providing this lens 2021, the dimension in the height direction of FIG. 10 is increased by the amount corresponding to the physical size of the lens 2021, so that the housing 2005 cannot be miniaturized.

FIG. 11 is a diagram showing a cause of generating optical crosstalk, and the structure is the same as shown in FIG. 10. In the structure of FIG. 11, a space is provided between the prism 2004 and the lens 2021 of the receiver 2002. Therefore, a light component (stray light as indicated by dotted lines in FIG. 11) not coupled to the optical fiber 2003 out of emission light from the transmitter 2001 leaks to the light receiving element 2022 of the receiver 2002 and is detected, so that a phenomenon of reception characteristic deterioration (optical crosstalk deterioration) of the receiver 2002 may occur. The optical crosstalk is greatly affected by the positional relationship between the transmitter 2001 and the receiver 2002 (the light receiving element 2022), and the effect of the stray light is greater as the positional relationship between the transmitter 2001 and the receiver 2022 is closer. Accordingly, in the conventional construction, the miniaturization and the suppression of the optical crosstalk deterioration cannot be performed at the same time.

It is an aspect of the present invention to reduce if not solve the above problem of the conventional technique, and to provide a single core bidirectional optical device which may be miniaturized and also suppress optical crosstalk deterioration.

### SUMMARY

A single core bidirectional optical device having a light emitting element that is provided to the terminal of one optical fiber and makes light incident to the optical fiber, and a light receiving element for receiving light of the optical fiber, comprises a wavelength multiplexing/demultiplexing coupler that is provided on an optical axis of light incident to and emitted from the optical fiber and contains therein wavelength separating film for separating the light to light of one side and light of another side every wavelength; the light emitting element provided on the direction of the light of the one side which is separated by the wavelength multiplexing/demultiplexing coupler; and the light receiving element provided on the direction of the light of the other side which is separated by the wavelength multiplexing/demultiplexing coupler, wherein the wavelength multiplexing/demultiplexing coupler is directly mounted on a light receiving face of the light receiving element.

### BRIEF DESCRIPTION OF THE DRAWINGS

FIG. 1 is a side cross-sectional view showing the structure of a single core bidirectional optical device;

FIG. 2 is an enlarged view showing a wavelength multiplexing/demultiplexing coupler portion;

FIG. 3 is a diagram showing the relationship between the distance between an optical fiber and PD and a distance-based beam diameter;

FIG. 4 is a diagram showing a construction where light reflection preventing film is provided to the wavelength multiplexing/demultiplexing coupler;

FIG. 5 is a diagram showing a construction where light reflection separating film is provided to the wavelength multiplexing/demultiplexing coupler;

FIG. 6 is a diagram showing the wavelength multiplexing/demultiplexing coupler adapted to end face polishing of an optical fiber;

FIG. 7 is a diagram showing an example of a housing structure for changing the travel direction of stray light;

FIG. 8 is a diagram showing another example of the housing structure for changing the travel direction of stray light;

FIG. 9A is a diagram showing another example of the housing structure for changing the travel direction of stray light;

FIG. 9B is a cross-sectional view of FIG. 9A;

FIG. 10 is a side cross-sectional view showing the structure of a conventional single core bidirectional optical device; and

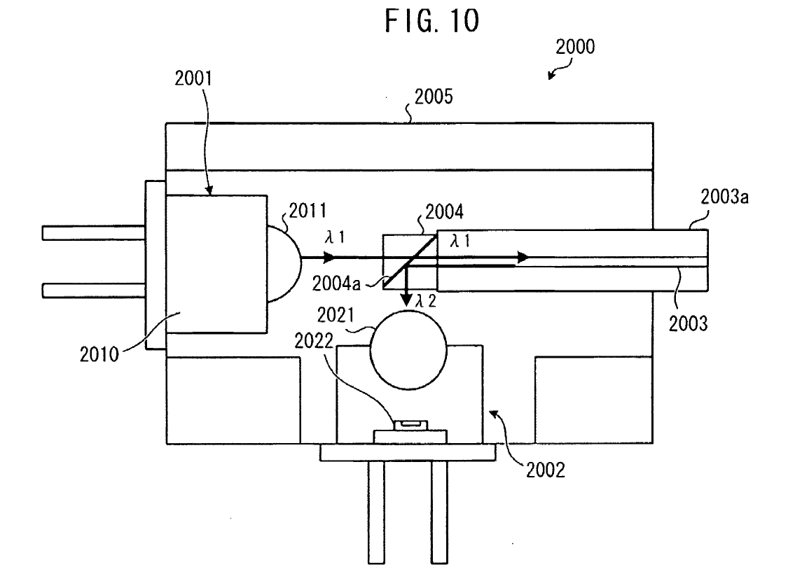

FIG. 11 is a diagram showing a cause of generating optical crosstalk.

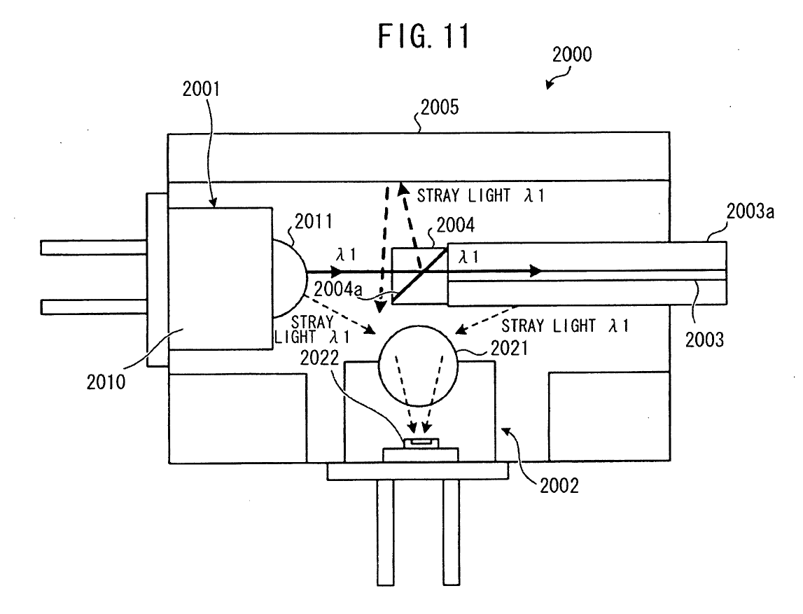

### DETAILED DESCRIPTION OF THE EMBODIMENTS

### First Embodiment

An embodiment of a single core bidirectional optical device according to the present invention will be described hereunder with reference to the accompanying drawings.

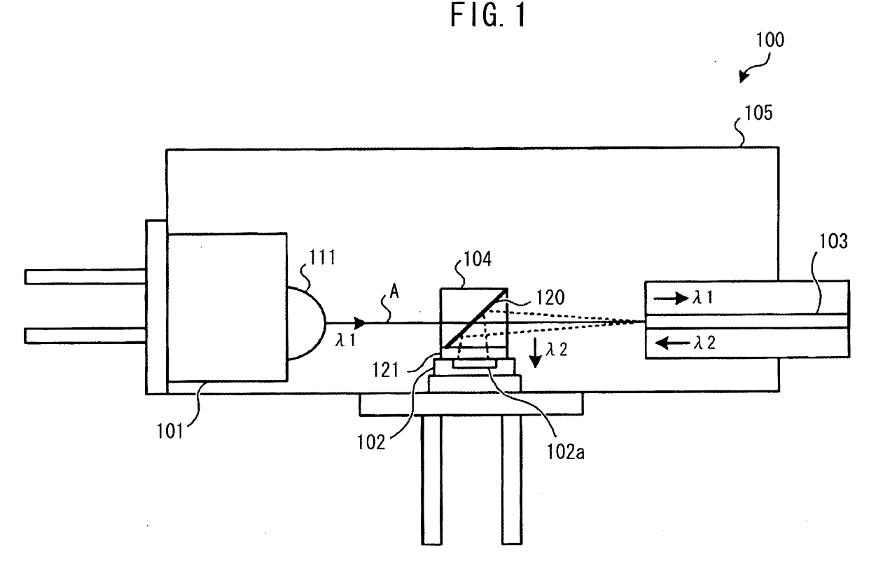

FIG. 1 is a side cross-sectional view showing the structure of a single core bidirectional optical device. The single core bidirectional optical device 100 comprises a transmitter 101, a light receiving element 102, an optical fiber 103, and a wavelength multiplexing/demultiplexing coupler 104 which are accommodated in a housing 105.

The single core bidirectional optical device 100 may be applied to a station-side device (OLT: an Optical Line Terminal) disposed at the end portion (terminal) of the optical fiber 103 in an optical fiber subscriber communication network, or to an optical transceiver such as a subscriber terminal device (ONU: Optical Network Unit), or the like.

The transmitter 101 is a package having a laser diode (LD) as a light-emitting element therein. The transmitter 101 generates light having a given wavelength λ1 and emits the light through a lens 111. The transmission light of the wavelength λ1 is emitted to the optical fiber 103 in an optical axis A direction. The wavelength multiplexing/demultiplexing coupler 104 is disposed on the optical axis A.

Furthermore, the light receiving element 102 is provided so that the light receiving face 102a thereof is perpendicular to the optical axis A. The light receiving element 102 receives light of a given wavelength λ2. Here, the wavelength λ1 of the transmission light of the transmitter 101 and the wavelength λ2 of the reception light of the light receiving element 102 are set to different wavelengths.

The wavelength multiplexing/demultiplexing coupler 104 is provided on the light receiving face 102a of the light receiving element 102. The wavelength multiplexing/demultiplexing coupler 104 is constructed as a cubic prism. The wavelength multiplexing/demultiplexing coupler 104 is provided with wavelength separating film 120 therein such that the wavelength separating film 120 is inclined at an angle of preferably 45° to the optical axis A. The wavelength separating film 120 has a wavelength separating characteristic such that light having a given wavelength is transmitted therethrough, but light having a different wavelength is reflected. In the example shown in FIG. 1, the light of the wavelength λ1 of the transmission light on the optical axis A is transmitted, and the reception light of the wavelength λ2 is reflected and led in a different direction.

Accordingly, the reception light of the wavelength λ2 which is emitted from the optical fiber 103 is reflected to the light receiving face 102a of the light receiving element 102 perpendicular to the optical axis A by the wavelength separating film 120 of the wavelength multiplexing/demultiplexing coupler 104, and detected by the light receiving element 102.

The wavelength multiplexing/demultiplexing coupler 104 is provided with wavelength separating film (second wavelength separating film) 121 on the face (bottom surface) thereof which is coupled to the light receiving element 102. This wavelength separating film 121 has the opposite light transmission characteristic of the wavelength separating film 120. That is, it has the characteristic in which the light of the wavelength λ1 is reflected therefrom and the light of the wavelength λ2 is transmitted therethrough. By providing the wavelength separating film 121 on the light receiving face 102a of the light receiving element 102, only reception light of a desired wavelength λ2 can be received by the light receiving element 102, and the incidence of the transmission light of the wavelength λ1 can be reduced.

The wavelength separating film 120 and 121 may be constructed by SWPF (Short Wave Pass Filter, also referred to as Low Pass Filter) or LWPF (Long Wave Pass Filter, also referred to as High Pass Filter). For example, with respect to the wavelength separating film 120, the wavelength λ1 of the transmission light may be set to 1.49 μm, and the wavelength λ2 of the reception light may be set to 1.3 μm. In this case, the wavelength separating film may be constructed by LWPF for transmitting the transmission light of the wavelength λ1 and reflecting the reception light of the wavelength λ2. The wavelength separating film 121 may be constructed by SWPF for reflecting the transmission light of the wavelength λ1 and transmitting the reception light of the wavelength λ2.

According to the above construction, no lens is used in the light receiving portion (on the incident passage to the light receiving element 102). If no lens is used and the wavelength multiplexing/demultiplexing coupler 104 is directly mounted on the light receiving face 102a of the light receiving element 102, it is unnecessary to take the focal distance of the lens into consideration in the case where a lens (optical system) is used. Furthermore, the light receiving portion may be constructed with only the light receiving element 102, and thus it is unnecessary to provide a lens, so that the device itself can be miniaturized by the amount corresponding to the height of the lens.

According to the above construction, the wavelength multiplexing/demultiplexing coupler 104 is directly mounted on the light receiving element 102, and thus it is possible to reduce if not eliminate a gap into which a part of the transmission light (stray light) of the wavelength λ1 emitted from the transmitter 101 may enter. In addition, the wavelength separating film 121 through which only the reception light of the wavelength λ2 is allowed to pass is provided at the lower surface of the wavelength multiplexing/demultiplexing coupler 104. Accordingly, even when stray light of the wavelength λ1 exists, light incident to the light receiving face 102a of the light receiving element 102 passes through this wavelength separating film 121, so that wavelengths other than the reception light of the wavelength λ2 can be reduced if not cut by the wavelength separating film 121. Accordingly, occurrence of optical crosstalk, which is caused by contamination of the transmission light of the wavelength λ1 into the reception light of the wavelength λ2, can be suppressed. Accordingly, both the miniaturization of the single core bidirectional optical device 100 and the suppression of the optical crosstalk deterioration can be achieved.

The combination of the wavelength λ1 of the transmission light and the wavelength λ2 of the reception light may be freely selected insofar as they are different wavelengths. For example, when the wavelength λ1 of the transmission light is set to 1.3 μm, the wavelength λ2 of the reception light may be set to 1.49 μm or 1.55 μm. Furthermore, when the wavelength λ1 of the transmission light is set to 1.49 μm, the wavelength λ2 of the reception light may be set to 1.3 μm or 1.55 μm. Furthermore, when the wavelength λ1 of the transmission light is set to 1.55 μm, the wavelength λ2 of the reception light may be set to 1.3 μm or 1.49 μm.

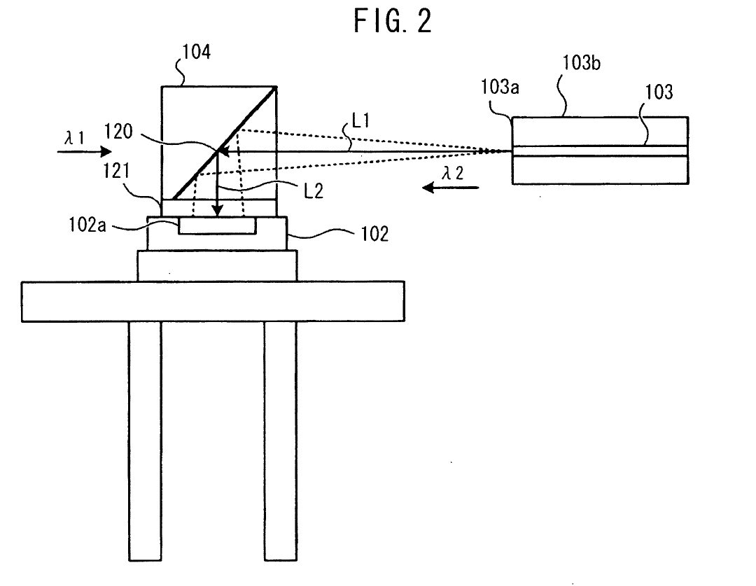

FIG. 2 is an enlarged view showing the wavelength multiplexing/demultiplexing coupler portion. As shown in FIG. 2, a wavelength multiplexing/demultiplexing coupler 104 may be fixed onto the light receiving face 102a of the light receiving element 102 by using an epoxy-type optical adhesive agent, for example. Diffusion light from the end face 103a of the optical fiber 103 is not condensed by a lens, but directly applied to the light receiving face 102a. The ferrule 103b is provided near to the end face 103a of the optical fiber 103 and fixed to the housing 105.

If the area of the wavelength separating film 121 provided at the bottom surface of the wavelength multiplexing/demultiplexing coupler 104 is set to be sufficiently larger than that of the light receiving face 102a of the light receiving element 102 as shown in FIG. 2, virtually no gap occurs between the light receiving face 102a of the light receiving element 102 and the wavelength separating film 121. Accordingly, even when stray light of the wavelength λ1 emitted from the transmitter 101 reflects diffusely in the housing 105 in any angle, the stray light of the wavelength λ1 cannot pass through the wavelength separating film 121 of the wavelength multiplexing/demultiplexing coupler 104. Thus, the stray light can be reduced if not prevented from being incident into the light receiving face 102a of the light receiving element 102.

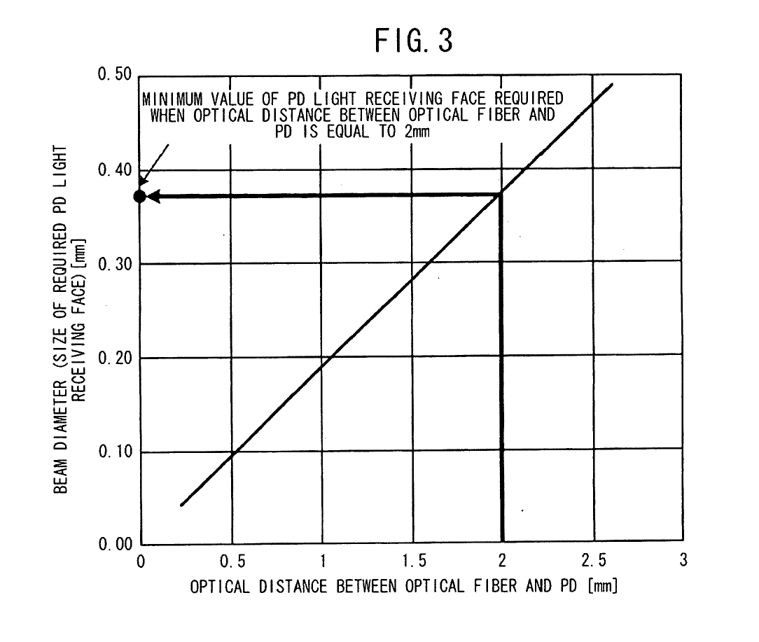

FIG. 3 is a diagram showing the relationship of the distance between the optical fiber and the light receiving element (PD) and the distance-based beam diameter. The distance L between the optical fiber and the light receiving element (PD) is equal to the sum of the distance L1, which is the distance from the end face 103a of the optical fiber 103 to the wavelength separating film 120 in the wavelength multiplexing/demultiplexing coupler 104, and the distance L2, which is the distance from the wavelength separating film 120 to the light receiving face 102a (see FIG. 2). The area of the light receiving face 102a is set to be equal to or larger than the beam diameter shown in FIG. 3. That is, the area of the light receiving face 102a is determined in accordance with an optical length which extends from the end face 103a of the optical fiber 103 to the wavelength separating film 120, and then from the wavelength separating film 120 to the light receiving face 102a.

In the example of FIG. 3, when the optical distance between the end face 103a of the optical fiber 103 and the light receiving face 102a is equal to 2 mm, the beam diameter, that is, the area of the light receiving face 102a is equal to about φ0.4 mm. At this time, the size of the wavelength multiplexing/demultiplexing coupler 104 may be implemented by setting the length of each side of the square-shaped cube to about 1 mm.

As described above, according to the above construction, the distance can be reduced by the amount corresponding to the size of the lens which has been hitherto required, by the distance between the lens and the PD, and by the optical distance required when the lens is used, whereby the size of the device (particularly in the height direction of FIG. 1) may be reduced to about half as much as compared to the prior art.

In the above construction, the wavelength multiplexing/demultiplexing coupler 104 and the ferrule 103b of the optical fiber 103 are not adhesively attached to each other. However, the present invention is not limited to this style. For example, from the relationship of FIG. 3, if the optical length (L1+L2) in the wavelength multiplexing/demultiplexing coupler 104 is set to 1 mm and the size of the light receiving face 102a of the light receiving element 102 is set to φ0.2 mm or more, the wavelength multiplexing/demultiplexing coupler 104 and the ferrule 103b may be adhesively attached to each other.

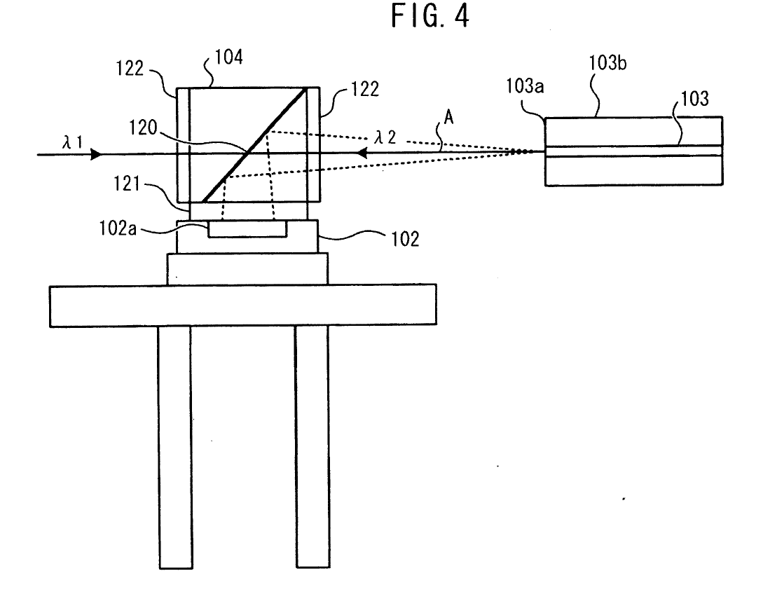

In addition to the above construction, the following construction may be added. FIG. 4 is a diagram showing a construction where light reflection preventing film is provided on the wavelength multiplexing/demultiplexing coupler 104. As shown in FIG. 4, light reflection preventing film 122 such as AR (antireflection) film or the like is provided on the faces of the wavelength multiplexing/demultiplexing coupler 104 located at the optical axis A side, that is, the face to which the transmission light of the wavelength λ1 is incident and the face to which the reception light of the wavelength λ2 is incident. By providing the light reflection preventing film 122, the reflectivity when light propagating in space is incident to the wavelength multiplexing/demultiplexing 104 is reduced to thereby enhance the transmissivity.

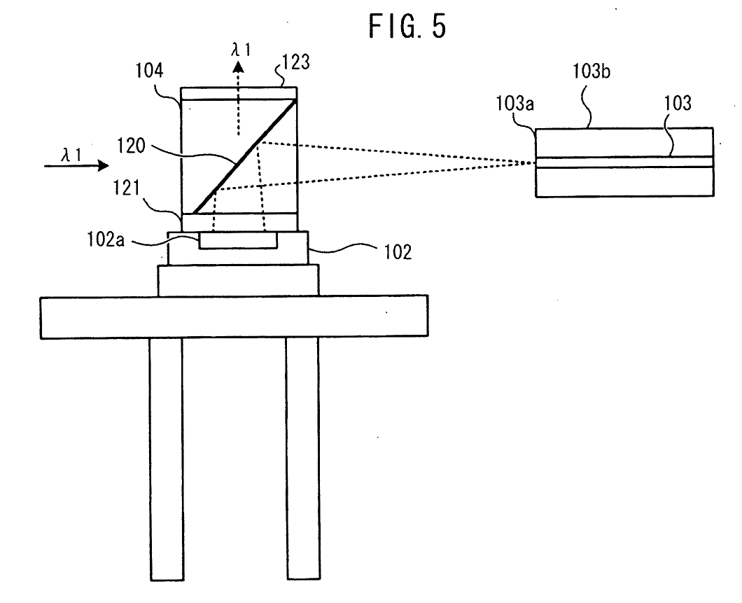

FIG. 5 is a diagram showing the construction where the reflection separating film is provided at the wavelength multiplexing/demultiplexing coupler. Wavelength separating film 123, which has the same characteristic as the wavelength separating film 120 provided in the wavelength multiplexing/demultiplexing coupler 104, is provided on the face of the wavelength multiplexing/demultiplexing coupler 104 to/from which no light is incident/emitted, that is, on the upper face of the wavelength multiplexing/demultiplexing coupler 104 in FIG. 5. Accordingly, the wavelength separating film 123 allows a light component of the transmission light traveling upwardly from the inside of the wavelength multiplexing/demultiplexing coupler 104 (the wavelength separating film 120) to pass therethrough to the outside. The wavelength separating film 123 also suppresses the transmission light of the wavelength λ1 from being reflected to the inside of the wavelength multiplexing/demultiplexing coupler 104 again and reduces the transmission light of the wavelength λ1 directed to the light receiving element 102.

The construction of the light reflection preventing film 122 shown in FIG. 4 and the construction of the wavelength separating film 123 shown in FIG. 5 may be used in combination to enhance the characteristic of the wavelength multiplexing/demultiplexing coupler 104. Thus, the deterioration of the optical crosstalk in the light receiving element can be greatly suppressed.

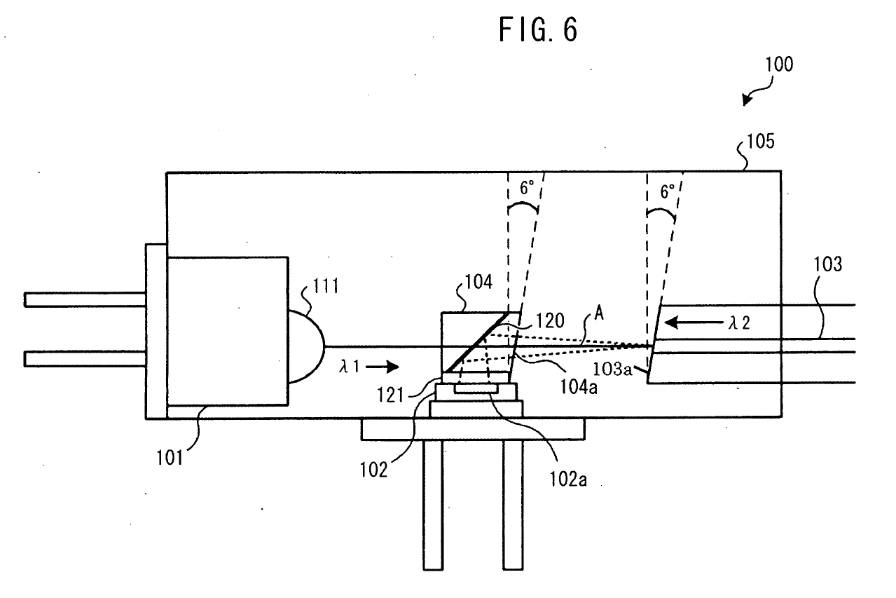

FIG. 6 is a diagram showing the wavelength multiplexing/demultiplexing coupler which is adapted to the end face polishing of the optical fiber. The optical fiber 103 may be constructed so that the end face 103a thereof is polished to reduce reflected return light of the reception light emitted from the end face 103a. As shown in FIG. 6, the end face 103a of the optical fiber 103 may be polished at a given angle (at 6° in the example of FIG. 6) in a direction perpendicular to the optical axis A.

When the end face of the optical fiber is polished as described above, the following disadvantage may occur if the wavelength multiplexing/demultiplexing coupler 104 of the above embodiment is used as is. First, the angle of the face of the wavelength multiplexing/demultiplexing coupler 104 which faces the end face 103a of the optical fiber 103 is set to 0°, so that the angle of the incident/emission face of the wavelength multiplexing/demultiplexing coupler 104 and the angle of the end face 103a of the optical fiber 103 are different from each other. This causes an angle loss and thus the coupling efficiency of the fiber is degraded. Particularly, when the transmission light of the wavelength λ1 is not coupled to the optical fiber 103, the transmission light of the wavelength λ1 becomes stray light in the housing 105.

Therefore, when the optical fiber 103 whose end face 103a is polished is used, the face (light incident/emission face) 104a of the wavelength multiplexing/demultiplexing coupler 104, which faces the end face 103a of the optical fiber 103, as well as the wavelength multiplexing/demultiplexing coupler 104 with a given angle (for example, 6°) is used. That is, the face 104a of the wavelength multiplexing/demultiplexing coupler 104 and the end face 103a of the optical fiber 103 are designed to be inclined at substantially the same angle (for example, 6°). Accordingly, the angle loss between the end face 103a of the optical fiber 103 and the face 104a of the wavelength multiplexing/demultiplexing coupler 104 can be minimized and thus the coupling efficiency can be enhanced. Accordingly, the stray light component of the transmission light of the wavelength λ1 in the housing 105 can be reduced, and the optical crosstalk can be suppressed.

One or both of the reflection preventing films 122 shown in FIG. 4 and the wavelength separating film 123 shown in FIG. 5 may be used alone or in combination in the construction shown in FIG. 6, whereby the characteristic of the wavelength multiplexing/demultiplexing coupler 104 can be enhanced. In addition, the coupling efficiency between the wavelength multiplexing/demultiplexing coupler 104 and the optical coupler 103 can be enhanced so that the stray light component from the transmission light of the wavelength λ1 can be reduced in the housing 105, and the deterioration of the optical crosstalk in the light receiving element 102 can be suppressed.

According to aspects of the first embodiment described above, the wavelength multiplexing/demultiplexing coupler 104 having the wavelength separating film 120 is directly mounted on the light receiving element 102. Therefore, it is unnecessary to dispose a lens on the optical path of the reception light, and the device can be miniaturized in the height direction by the amount corresponding to the eliminated lens and also the cost can be reduced. Furthermore, the stray light component of the transmission light of the wavelength λ1 is blocked by the wavelength separating film 121, and prevented from being incident to the light receiving element 102, and thus the optical crosstalk deterioration can be suppressed.

### Second Embodiment

Next, a second embodiment according to the present invention will be described.

In the second embodiment, the internal structure of the housing is improved so that the stray light of the transmission light of the wavelength λ1 is deflected away from the direction of the light receiving element 102 to thereby suppress the optical crosstalk deterioration. That is, the device is provided with an optical path changing unit for intentionally deflecting stray light reflected from the internal wall surface of the housing 105 away from the incident direction to the light receiving element 102. In the construction of the second embodiment, the wavelength multiplexing/demultiplexing coupler 104 described with reference to the first embodiment is used.

The most common component (which makes up about 90% of all components) of stray light received by the light receiving element 102 is a light component obtained when the transmission light of the wavelength λ1 from the transmitter 101 is reflected from the wavelength separating film 120 of the wavelength multiplexing/demultiplexing coupler 104 and then emitted to the outside of the wavelength multiplexing/demultiplexing coupler 104, and becomes stray light in the housing 105. The wavelength multiplexing/demultiplexing coupler 104 is provided with the wavelength separating film 121 for blocking incidence of this stray light of the wavelength λ1 into the light receiving element 102; however, the wavelength separating film 121 cannot perfectly block the incidence of the stray light of the wavelength λ1 although the film has a given wavelength characteristic.

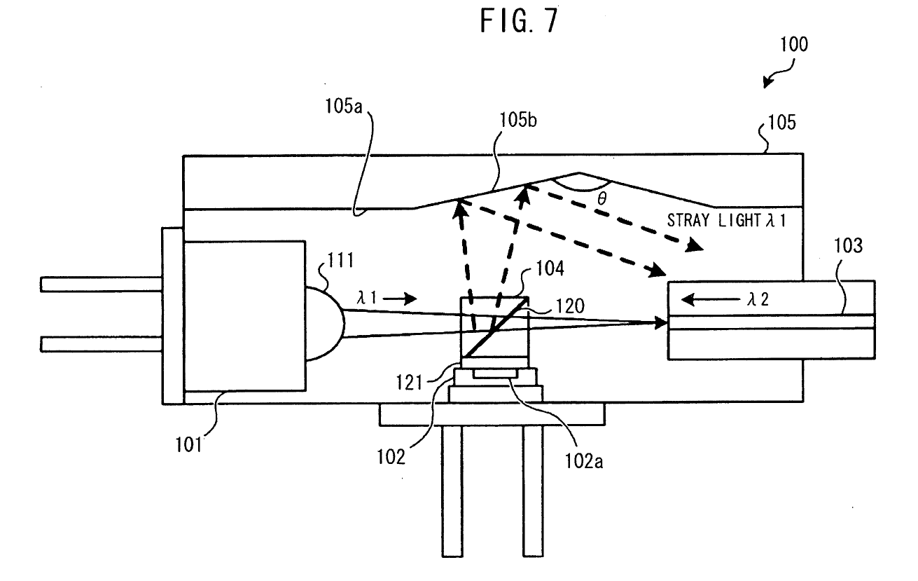

FIG. 7 is a diagram showing an example of the housing structure of changing the travel direction of the stray light. As shown in FIG. 7, the inner wall surface of the housing 105 is processed so as to deflect stray light components (dotted lines in FIG. 7) of the transmission light of the wavelength λ1 so that the stray light is not directed to the light receiving element 102, thereby forming the optical path changing unit. In the example of FIG. 7, a slanted face 105b having a given angle θ (for example, 120°) is formed on the inner surface 105a which faces the wavelength multiplexing/demultiplexing coupler 104. The slanted face 105b, which is above the wavelength multiplexing/demultiplexing coupler 104, is inclined toward the optical fiber 103. The slanted face 105b may be formed, for example, by cutting a groove having the angle θ on the inner surface 105a of the housing 105.

The traveling direction of stray light component of the wavelength λ1 traveling from the wavelength multiplexing/demultiplexing coupler 104 toward the inner surface 105a of the housing 105 is deflected toward the optical fiber 103 by the slanted surface 105b, so that the stray light component is deflected away from the direction to the light receiving element 102. Accordingly, the incidence of the transmission light of the wavelength λ1 to the light receiving face 102a of the light receiving element 102 can be suppressed.

An actual measurement result of crosstalk values will be described.

When the processing of the slanted surface 105b is not provided on the housing 105, the crosstalk value=38.0 dB.

(2) When the processing of the slanted surface 105b of FIG. 7 is provided on the housing 105, the crosstalk value=49.3 dB.

As described above, the performance can be enhanced by about 11 dB by providing the slanted surface 105b shown as an example in FIG. 7.

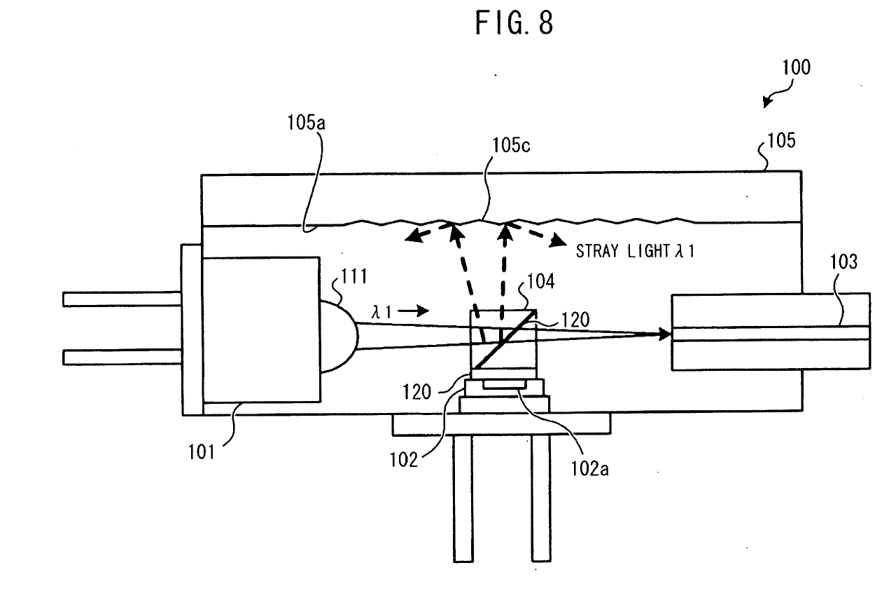

FIG. 8 is a diagram showing another example of the housing structure for changing the travel direction of the stray light. In the example of FIG. 8, a minutely uneven face 105c is formed on a portion of the inner surface 105a of the housing 105 which faces the wavelength multiplexing/demultiplexing coupler 104. The uneven face 105c may be formed by sandblast processing used in burring processing, or the like.

The stray light component of the wavelength λ1 traveling from the wavelength multiplexing/demultiplexing coupler 104 to the inner surface 105a of the housing 105 is diffusely reflected by the uneven face 105c so that the stray light component of the wavelength λ1 traveling to the light receiving element 102 can be reduced.

An actual measurement result of the crosstalk value is described.

When the processing of the uneven face 105c is not provided on the housing 105, the crosstalk value=40.5 dB.

When the processing of the uneven face 105c of FIG. 8 is provided on the housing 105, the crosstalk value=45.9 dB.

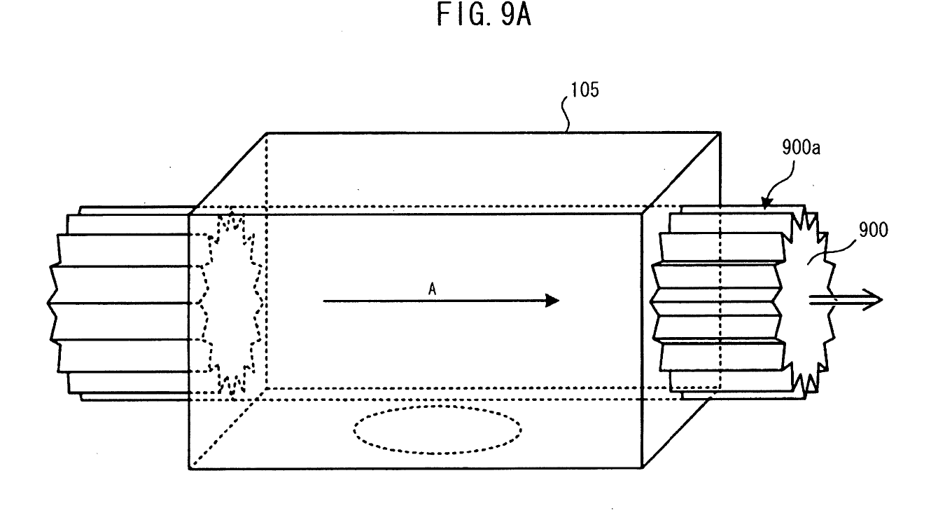

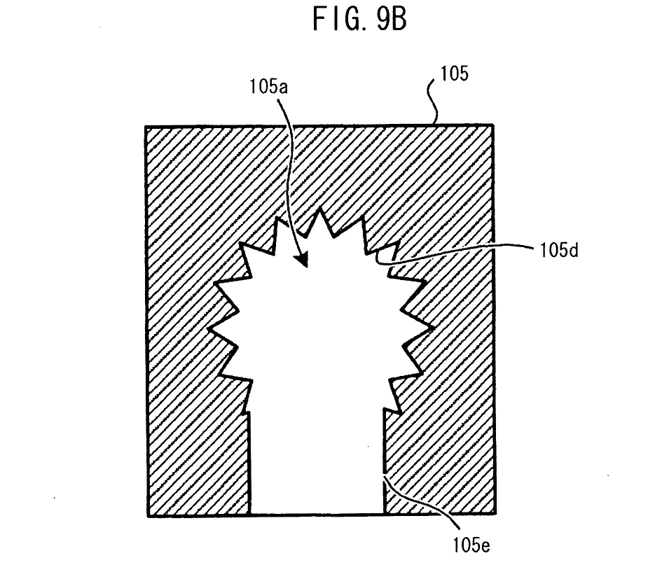

FIG. 9A is a diagram showing another example of the housing structure for changing the travel direction of the stray light. FIG. 9B is a cross-sectional view of FIG. 9A. The housing 105 of these figures is manufactured by casting mold. In the manufacturing process, a trimming die 900 is placed along the optical axis A in the housing 105. The trimming die 900 is designed in a substantially cylindrical shape, and an uneven portion 900a is formed on the outer peripheral surface of the cylindrical trimming die 900. Accordingly, as shown in FIG. 9B, an uneven face 105d corresponding to the shape of the uneven portion 900a of the trimming die 900 is formed in the housing 105 from which the trimming die 900 is removed. An opening portion 105e for fixing the light receiving element 102 on the lower surface of the housing 105 is formed by a drill or the like.

The transmitter 101, the light receiving element 102, the optical fiber 103, and the wavelength multiplexing/demultiplexing coupler 104 described above are provided in the housing 105. In this construction, the stray light component of the wavelength λ1 traveling from the wavelength multiplexing/demultiplexing coupler 104 toward the inner surface 105a of the housing 105 is also diffusely reflected from the uneven face 105d so that the stray light component of the wavelength λ1 traveling to the light receiving element 102 can be reduced. Accordingly, the optical crosstalk deterioration can be suppressed.

As described above, the construction where the housing 105 is processed as described above is not limited to the above embodiments. For example, the uneven surface 105c shown in FIG. 8 may be formed on the slant surface 105b shown in FIG. 7. In addition, coating of black color or the like for reducing light reflection may be applied to the inner surface 105a of the housing 105.

Furthermore, according to the above embodiment, any construction of any aspect of the second embodiment may be arbitrarily combined with any construction of any aspect of the first embodiment. The degree of suppressing the optical crosstalk deterioration obtained by the construction of aspects of the first embodiment can be enhanced by the construction of aspects of the second embodiment. That is, the wavelength multiplexing/demultiplexing coupler 104 described with reference to the first embodiment can, by the wavelength separating film 121, reduce if not prevent the entry of the stray light of the wavelength λ1 into the light receiving element 102. However, the stray light cannot be completely blocked. However, by deflecting the travel direction of the stray light of the wavelength λ1 itself from the light receiving element 102 as in the case of aspects of the second embodiment, the main component of the stray light itself can be reduced if not prevented from traveling to the light receiving element 102. Accordingly, the deterioration of the reception characteristic by the optical crosstalk can be greatly reduced as compared to only the wavelength λ1 blocking characteristic of the wavelength separating film 121.

According to an aspect of the present invention, there can be provided a single core bidirectional optical device that can reduce if not solve the conflicting problems of miniaturization and suppression of deterioration of the light reception characteristic caused by the optical crosstalk.

What is claimed is:

1. A single core bidirectional optical device having a light emitting element that is provided at the terminal of one optical fiber and makes light incident to the optical fiber, and having a light receiving element for receiving light of the optical fiber, comprising:
a wavelength multiplexing/demultiplexing coupler that is provided on an optical axis of light incident to and emitted from the optical fiber and includes therein wavelength separating film for separating the light to light of one side and to light of another side for every wavelength;
the light emitting element provided on the direction of the light of the one side which is separated by the wavelength multiplexing/demultiplexing coupler; and
the light receiving element provided on the direction of the light of the other side which is separated by the wavelength multiplexing/demultiplexing coupler, wherein the wavelength multiplexing/demultiplexing coupler is directly mounted on a light receiving face of the light receiving element.

2. The single core bidirectional optical device according to claim 1, wherein the light emitting element is provided on the optical axis, the light receiving element is provided in a direction perpendicular to the optical axis, and the wavelength separating film provided in the multiplexing/demultiplexing coupler has a wavelength characteristic in which light having a first wavelength emitted from the light emitting element is transmitted to the optical fiber side, and light having a second wavelength emitted from the optical fiber is reflected to the light receiving element side.

3. The single core bidirectional optical device according to claim 2, wherein the wavelength multiplexing/demultiplexing coupler is provided with a second wavelength separating film on a face thereof which is brought into contact with the light receiving face of the light receiving element, the second wavelength separating film having a wavelength characteristic in which the light of the first wavelength emitted from the light emitting element is blocked and the light of the second wavelength emitted from the optical fiber is transmitted.

4. The single core bidirectional optical device according to claim 2, wherein a space having a given length is provided between the end face at the terminal of the optical fiber and the wavelength multiplexing/demultiplexing coupler, and the size of the light receiving face of the light receiving element is determined in accordance with an optical length from the end face of the optical fiber to the wavelength multiplexing/demultiplexing coupler and from the wavelength multiplexing/demultiplexing coupler to the light receiving element.

5. The single core bidirectional optical device according to claim 1, wherein the wavelength multiplexing/demultiplexing coupler is a cubic-type wavelength multiplexing/demultiplexing coupler, and the wavelength separating film is formed in the cubic-type wavelength multiplexing/demultiplexing coupler so as to be inclined at an angle of substantially 45° with respect to the optical axis.

6. The single core bidirectional optical device according to claim 5, wherein the wavelength multiplexing/demultiplexing coupler is provided with reflection preventing film on a face thereof located on the optical axis.

7. The single core bidirectional optical device according to claim 3, wherein reflection preventing film having substantially the same wavelength characteristic as the reflection preventing film provided in the wavelength multiplexing/demultiplexing coupler is provided on a face of the wavelength multiplexing/demultiplexing coupler which is opposite to the face thereof to which the light receiving element is secured.

8. The single core bidirectional optical device according to claim 2, wherein, when the end face of the optical fiber is inclined at a given angle, the wavelength multiplexing/demultiplexing coupler is configured so that a surface thereof which faces the optical fiber side is inclined at substantially the same given angle as the end face of the optical fiber.

9. The single core bidirectional optical device according to claim 8, wherein the given angle is set to 6° with respect to a direction perpendicular to the optical axis.

10. The single core bidirectional optical device according to claim 1, further comprising a housing for accommodating the respective elements, wherein the housing is provided with an optical path changing unit for deflecting a part of light emitted from the light emitting element to a direction different from the direction to the light emitting element.

11. The single core bidirectional optical device according to claim 10, wherein a slanted face, which is inclined at a given angle and changes a reflection direction of light, is formed at a portion of the inner surface of the housing which is located so as to face the wavelength multiplexing/demultiplexing coupler.

12. The single core bidirectional optical device according to claim 10, wherein the optical path changing unit is constructed by forming an uneven face for scattering light on the inner surface of the housing.
